(19) United States
(12) Patent Application Publication
(10) Pub. No.: US 2011/0154715 A1
(43) Pub. Date: Jun. 30, 2011

(54) COMPACT FAKE BAIT STRUCTURE

(76) Inventor: Tsung-Hsi Tsai, Changua City (TW)

(21) Appl. No.: 12/647,460

(22) Filed: Dec. 26, 2009

(51) Int. Cl. A01K 85/00

(52) U.S. Cl. 43/42.39

(57) ABSTRACT

A compact fake bait structure includes a transparent fake bait and a colored counterweight fake bait. The colored counterweight fake bait is located behind with the transparent fake bait and integrally formed with the transparent fake bait. The colored counterweight fake bait is provided with a hook. When the user tosses a fishing line, the fishing line can be tossed farther due to the gravitational acceleration of the colored counterweight fake bait. The colored counterweight fake bait colored with pattern can attract real fish to be hooked easily. Besides, the transparent fake bait is not easily to be seen so as to prevent the real fish from being frightened away.

### BACKGROUND OF THE INVENTION

1. Field of the Invention

The present invention relates to a compact fake bait structure, and more particularly, to one having a rear colored counterweight fake bait connected to a front transparent fake bait. The colored counterweight fake bait is located at the terminal, which can facilitate a fishing line to be tossed farther when flinging a fishing rod. The colored counterweight fake bait colored with pattern can attract small real fish to be hooked easily.

2. Description of the Prior Art

A fake fish is used as an auxiliary tool for fishing. The fake fish is provided with a plurality of fishhooks. The fake fish is brightly colored like a rear fish for attracting fish to approach the baits on the fishhooks so as to hook fish. However, the size of the fake bait is not uniform. If the fake bait is too big, the real fish won't dare to approach the fake bait. If the fake bait is too small, the fake bait will be very light, so that the fishing line can't be tossed far.

### SUMMARY OF THE INVENTION

The primary object of the present invention is to provide a compact fake bait structure which comprises a transparent fake bait and a colored counterweight fake bait. The colored counterweight fake bait is located behind with the transparent fake bait and integrally formed with the transparent fake bait. The size of the colored counterweight fake bait is smaller than that of the transparent fake bait. The colored counterweight fake bait is provided with a hook. When the user tosses a fishing line, the fishing line can be tossed farther due to the gravitational acceleration of the colored counterweight fake bait. The colored counterweight fake bait colored with pattern can attract real fish to be hooked easily. Besides, the transparent fake bait is not easily to be seen so as to prevent the real fish from being frightened away.

Preferably, the transparent fake bait is in the form of a plurality of transparent fake baits which are connected one by one, and the last one is connected with the colored counterweight fake bait. The colored counterweight fake bait is located at the terminal, which can facilitate the fishing line to be tossed farther when flinging a fishing rod.

### BRIEF DESCRIPTION OF THE DRAWINGS

FIG. 1 is a front view of the present invention;

FIG. 2 is a side view of the present invention; and

FIGS. 3 and 4 are schematic views showing the operation of the present invention.

### DETAILED DESCRIPTION OF THE PREFERRED EMBODIMENT

Embodiments of the present invention will now be described, by way of example only, with reference to the accompanying drawings.

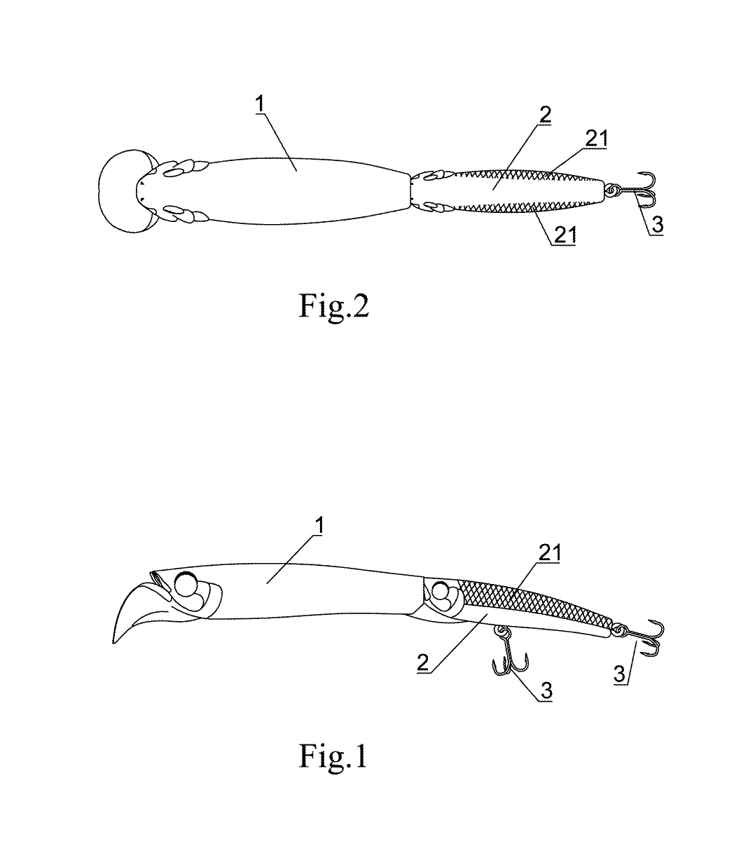

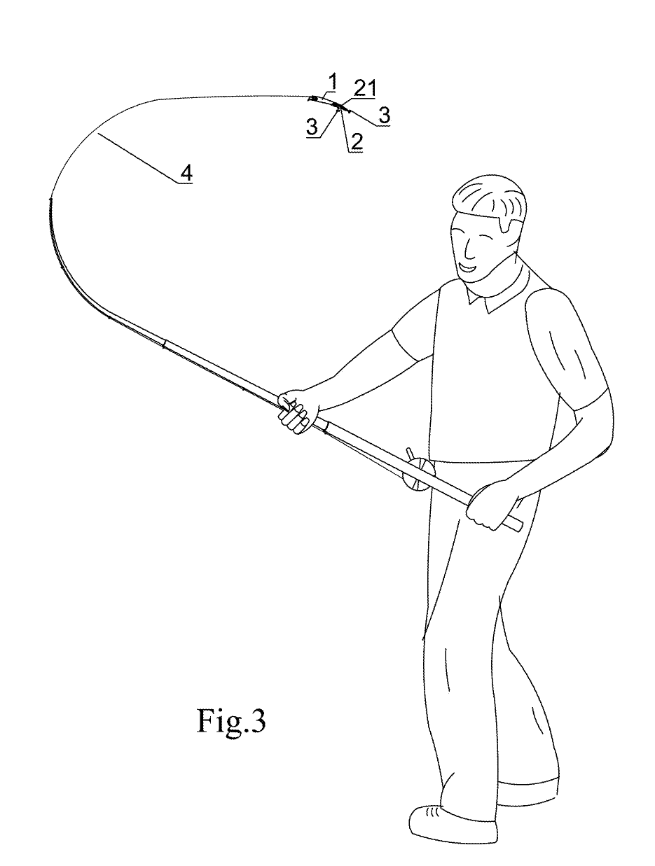

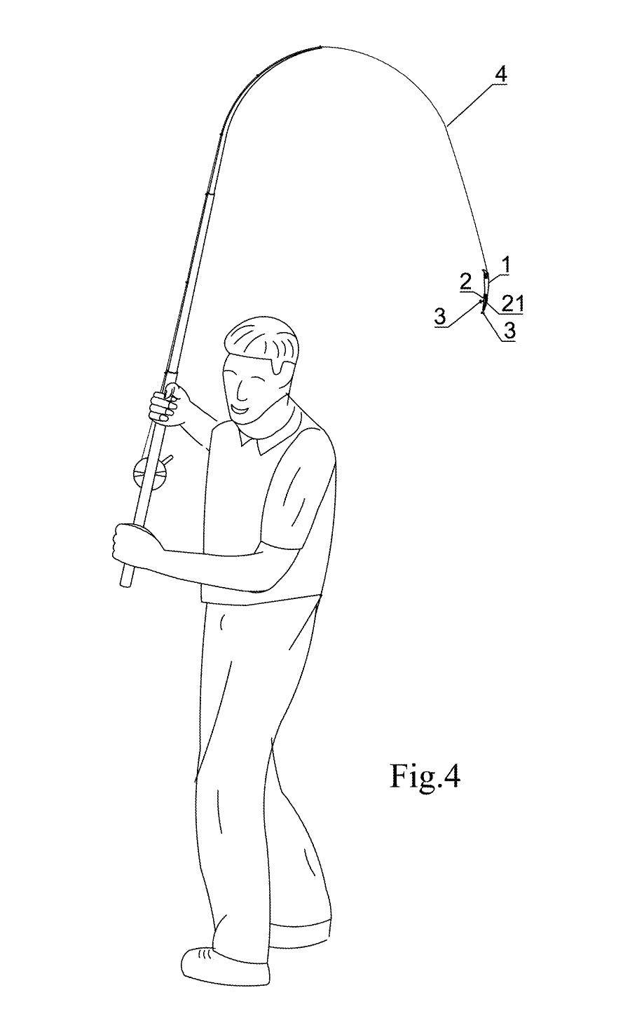

Referring to FIGS. 1 and 2, a compact fake bait structure according to a preferred embodiment of the present invention comprises a transparent fake bait 1 and a colored counterweight fake bait 2 located behind the transparent fake bait 1. The colored counterweight fake bait 2 is integrally formed with the transparent fake bait 1. The size of the colored counterweight fake bait 2 is smaller than that of the transparent fake bait 1. The colored counterweight fake bait 2 is provided with a hook 3. As shown in FIGS. 3 and 4, when the user tosses a fishing line 4, the fishing line 4 will be tossed farther due to the gravitational acceleration of the colored counterweight fake bait 2. The colored counterweight fake bait 2 colored with pattern 21 can attract real fish to be hooked easily. Besides, the transparent fake bait 1 is not easily to be seen, preventing the real fish from being frightened away.

Referring to FIG. 1, the transparent fake bait 1 can be in the form of a plurality of transparent fake baits 1 which are connected one by one, and the last one is connected with the colored counterweight fake bait 2. The colored counterweight fake bait 2 is located at the terminal, which can facilitate the fishing line 4 to be tossed farther when flinging a fishing rod.

The size of the colored counterweight fake bait 2 can be varied corresponding in size to the fish in sea water, lake water or river for attracting fish in different sizes to be hooked easily.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A compact fake bait structure, comprising a transparent fake bait and a colored counterweight fake bait which is integrally formed with the transparent fake bait.

2. The compact fake bait structure as claimed in claim 1, wherein the transparent fake bait is in the form of a plurality of transparent fake baits which are connected one by one, and the last one of the transparent fake baits is connected with the colored counterweight fake bait.
